(19) United States
(12) Patent Application Publication
(10) Pub. No.: US 2021/0300669 A1
(43) Pub. Date: Sep. 30, 2021

(54) PREFORM ASSEMBLY AND METHOD OF MANUFACTURING A PRESSURIZED POLYMERIC CONTAINER

(71) Applicant: The Procter & Gamble Company, Cincinnati, OH (US)

(72) Inventors: Douglas Bruce Zeik, Liberty Township, OH (US); Matthew Aaron Neumann, Montgomery, OH (US)

(21) Appl. No.: 17/216,757

(22) Filed: Mar. 30, 2021

Related U.S. Application Data
(60) Provisional application No. 63/002,380, filed on Mar. 31, 2020.

(51) Int. Cl. B65D 83/20; B65D 83/38; B65D 83/44; B29C 49/00

(52) U.S. Cl. CPC B65D 83/207; B65D 83/384; B29K 2067/003; B29C 49/0005; B65D 83/44

(57) ABSTRACT

A plural preform assembly including an outer preform and an inner preform. The outer preform includes an outer preform open end, an outer preform closed end longitudinally opposed thereto, and an outer preform sidewall joining the outer preform open end and the outer preform closed end. The inner preform may be disposed in the outer preform. The inner preform includes an inner preform open end, an inner preform closed end longitudinally opposed thereto, and an inner preform sidewall joining the inner preform open end and the inner preform closed end. The inner preform has an inner preform intrinsic viscosity and the outer preform has an outer preform intrinsic viscosity. The inner preform intrinsic viscosity and the outer preform intrinsic viscosity are different. The plural preform assembly may be blow molded into an article.

### FIELD

The present disclosure is directed to nested preforms for polymeric containers, and, in particular, to polymeric nested preforms having different intrinsic viscosities.

### BACKGROUND

Preforms are used to manufacture containers, such as drink containers and aerosol containers. The preform may be formed by injection molding. The injection molded preform may then be blow molded into a final shape, such as a container. The relationship between preform material, preform geometry, processing conditions, and the blow molded article geometry may all influence performance criteria of the blow molded article. Forming an article, such as an aerosol container may require multiple preforms, such as a two preforms. The greater the number of preforms, the greater the number of steps required to manufacture the container.

Thus, it would be beneficial to limit the number of manufacturing steps when more than one preform is needed to form a container or a component of the container.

### SUMMARY

The present disclosure is directed to apparatuses and methods for blow molding a plural preform assembly into an article, such as a pressurized container. The plural preform assembly may include two or more preforms. Each of the two or more preforms may have a different intrinsic viscosity.

A polymeric pressurized dispenser for dispensing a product may include a container. The container may include a closed end bottom and a neck longitudinally opposed to the closed end bottom. The neck may define an opening. A valve assembly may be disposed in the neck of the container. The valve assembly may include a valve body and a valve stem. The valve body may be joined to a portion of the container. The valve body may include an outer surface and an inner passageway extending about a longitudinal axis. The inner passageway may include a first passageway opening, a second passageway opening, and a passageway surface extending from the first passageway opening to the second passageway opening. The valve assembly also includes a valve stem that may extend through the inner passageway of the valve body. The valve stem may be slidably engaged with a portion of the valve body. A bag may be disposed within the container and a propellant may be disposed within the container. The propellant may be configured to pressurize the polymeric aerosol dispenser. The container has a container intrinsic viscosity and the bag has a bag intrinsic viscosity. The bag intrinsic viscosity may be less than the container intrinsic viscosity.

A plural preform assembly for a container may have a longitudinal axis extending in a longitudinal direction. The plural preform assembly may include an outer preform and an inner preform. The outer preform may have an outer preform open end and an outer preform closed end longitudinally opposed thereto. The outer preform may also include an outer preform sidewall that joins the outer preform open end and the outer preform closed end and an outer preform inner surface and an outer preform outer surface. The inner preform may be disposed in the outer preform. The inner preform may have an inner preform open end and an inner preform closed end longitudinally opposed thereto. The inner preform may also include an inner preform sidewall joining the inner preform open end and the inner preform closed end. The inner preform may include an inner preform inner surface and an inner preform outer surface. The inner preform has an inner preform intrinsic viscosity and the outer preform has an outer preform intrinsic viscosity. The inner preform intrinsic viscosity and the outer preform intrinsic viscosity are different.

A method of making a plural preform assembly for a bag in container assembly may include: providing a plural preform assembly having a longitudinal axis extending in a longitudinal direction, the plural preform assembly including: an outer preform having an outer preform open end and an outer preform closed end longitudinally opposed thereto, an outer preform sidewall joining the outer preform open end and the outer preform closed end, the outer preform having an outer preform inner surface and an outer preform outer surface; and an inner preform at least partially disposed in the outer preform, the inner preform having an inner preform open end and an inner preform closed end longitudinally opposed thereto, an inner preform sidewall joining the inner preform open end and the inner preform closed end, the inner preform having an inner preform inner surface and an inner preform outer surface, wherein the outer preform has an outer preform intrinsic viscosity and the inner preform has an inner preform intrinsic viscosity, and wherein the inner preform intrinsic viscosity is less than the outer preform intrinsic viscosity; loading the plural preform assembly into a mold cavity; and blow molding the plural preform assembly, wherein each of the inner preform and the outer preform are blown to substantially form to the mold cavity forming a bag in container assembly, wherein the plural preform assembly has a plural preform hoop stretch index of greater than about 1.1.

### BRIEF DESCRIPTION OF THE DRAWINGS

Several figures are provided to help the reader understand the invention. The figures are intended to be viewed in conjunction with the specification and are not intended to be limiting beyond that of the wording of the specification. Reference numbers are used to identify different features of the figures. The same reference numbers are used throughout the specification and drawings to show the same features, regardless of the variation of the invention that is depicted.

FIG. 1A is a side view of a plural preform assembly;

FIG. 1B is a cross-sectional view of the plural preform assembly taken about line 1B-1B of FIG. 1A;

FIG. 1C is a perspective view of a plural preform assembly;

FIG. 1D is a top view of a plural preform assembly;

FIG. 2A is a side view of an outer preform;

FIG. 2B is a cross-sectional view of the outer preform taken about line 2B-2B of FIG. 2A;

FIG. 2C is a perspective view of an outer preform assembly;

FIG. 3A is a side view of an outer preform;

FIG. 3B is a cross-sectional view of the outer preform taken about line 3B-3B of FIG. 3A;

FIG. 3C is a perspective view of an outer preform assembly;

FIG. 4A is a cross-sectional view of a plural preform assembly disposed within a mold cavity;

FIG. 4B is a cross-sectional view of an article disposed within a mold cavity;

FIG. 5A is a cross-sectional view of a preform disposed in a mold cavity;

FIG. 5B is a side view of an article;

FIG. 6A is a side view of an aerosol dispenser;

FIG. 6B is a side view of an aerosol dispenser;

FIG. 7A is a sectional view of an aerosol dispenser including a bag;

FIG. 7B is a sectional view of an aerosol dispenser including a dip tube;

FIG. 7C is a sectional view of an aerosol dispenser including a bag and a dip tube;

FIG. 8A is a partial, exploded, sectional view of a valve assembly, a product delivery device, and a container;

FIG. 8B is a partial, sectional view of a valve assembly, a product delivery device, and a container;

FIG. 9A is a perspective, sectional view of a valve assembly;

FIG. 9B is a side, exploded, sectional view of a valve assembly;

FIG. 10A is a perspective, sectional view of a valve assembly;

FIG. 10B is a side, exploded, sectional view of a valve assembly;

FIG. 11A is a graph illustrating the plural preform hoop stretch index v. the container diameter; and

FIG. 11B is a graph illustrating the inverse plural preform hoop stretch index v. the container diameter.

### DETAILED DESCRIPTION

The present disclosure is directed to an aerosol dispenser and, more specifically, a recyclable polymeric aerosol dispenser. An aerosol dispenser may include a container for containing a product and/or a propellant and a valve assembly for dispensing the product or the product and the propellant from the container. Other components may be included in the aerosol dispenser such as a nozzle for controlling the spray characteristics of a product as it discharged from the aerosol dispenser and an actuator for selectively dispensing product from the aerosol dispenser. Products may include, but are not limited to: shave cream, shave foam, body sprays, body washes, perfumes, hair cleaners, hair conditions, hair styling products, antiperspirants, deodorants, personal and household cleaning or disinfecting compositions, air freshening products, fabric freshening products, hard-surface products, astringents, foods, paint, pharmaceuticals, and insecticides. The relatively large number of products that may be dispensed using aerosols has made aerosols a popular choice among manufacturing companies. The relative popularity of aerosol dispensers has resulted in companies considering cost cutting measures with respect to aerosol dispensers. For example, manufacturers consider reducing the manufacturing cost and to consider materials, at least in part, for aerosol dispensers to minimize the environmental impact and increase compatibility with the recycling process. For example, an aerosol dispenser made from polymeric components may aid in the recyclability of the dispensers and help with reducing cost, such as by reducing the cost of manufacturing, eliminating expensive metal components, and reducing the cost of shipping, through weight reduction of each dispenser. Further, by using polymeric materials, the manufacturing costs may be reduced by, for example, by avoiding the use of more expense, such as metal components, and allowing for greater flexibility in combining process steps to form the dispenser. The use of different materials also allows for greater flexibly in the size and shape of the dispenser.

The present disclosure is directed to a polymeric plural preform assembly and a method of forming a container, such as a container used as a component of an aerosol dispenser. The plural preform assembly may be used to form any number of articles, such as containers. The relationship between the geometry and the material of the preform and the processing condition, such as the blow molding conditions, influence the final characteristics of the article. The present disclosure is directed to a plural preform assembly including at least two preforms where the two preforms have different intrinsic viscosities and other characteristics that allow for relatively reduced processing and relatively increased article performance, such as in the case of an aerosol dispenser.

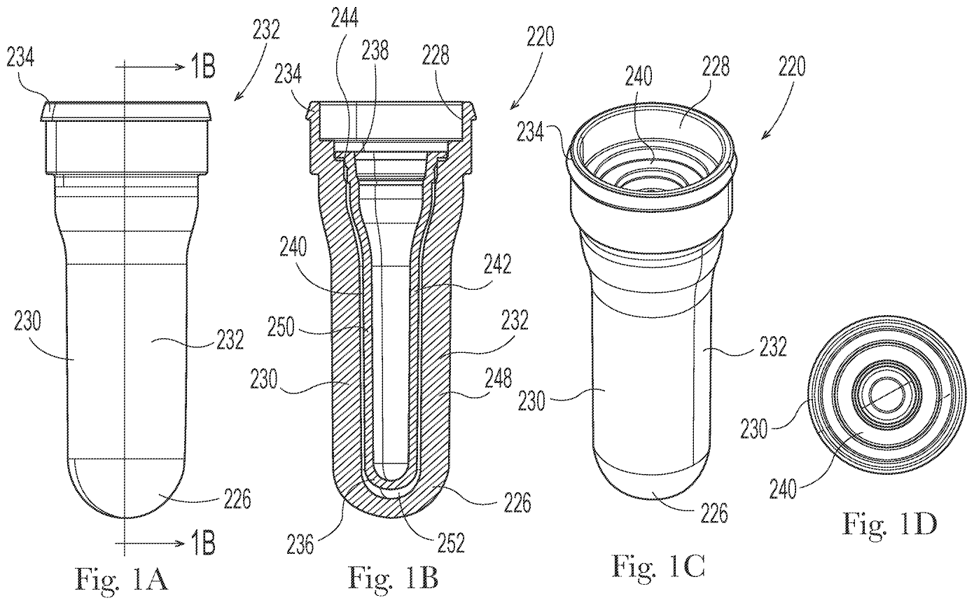

With reference to FIGS. 1A-1D, a plural preform assembly 220 including one or more preforms, which may be injection molded and nested together. More specifically, the plural preform assembly 220 may include an outer preform 230 and an inner preform 240 nested therein. Optionally, one or more intermediate preforms may be interposed between the outer preform 230 and inner preform 240. An optional intermediate preform may be internal to an outer preform 230 and external to an inner preform 240.

Each preform 230, 240 includes a finish 234, 244 and a body 232, 242 depending therefrom. The finish 234, 244 and body 232, 242 may be integral. The finish 234, 244 is generally not affected by subsequent molding operations. The body 232, 242 is generally blown to attenuate wall thickness and may increase in at least one of length and cross sectional area. Each preform 230, 240 may include a closed end 226, 236 and an open end 228, 238. The closed end 226, 236 may be opposite the open end 228, 238. The closed end 226, 236 may be joined by one or more sidewalls 248, 250 to the open end 228, 238. The sidewall 248, 250 may extend from the open end 228, 238 to the closed end 226, 236.

The plural preform assembly may be nested. By nested it is meant that a first preform, such as the inner preform 240, is inserted into a second preform, such as the outer preform 230, so that the outer preform finish 234 and the inner preform finish 244 are in mutual contact. For example, the inner preform 240 and the outer preform 230 may be concentrically spaced in the nested configuration. It is to be appreciated that any number of preforms may be nested. For example, the second preform may be nested into a third preform, and so on. For example, a first inner preform and a second inner preform may be spaced in a side-by-side configuration within an outer preform. The inner preform 240 may be directly nested into an outer preform 230, providing a dual preform assembly 220. The inner preform body 242 may contact at least a portion of the outer preform body 232, or the inner preform body 242 may be spaced away from the outer preform body 232. Having a configuration where the inner preform body 242 is spaced away from the outer preform body, such that a gap 252 is formed between at least a portion of the inner preform body 242 and the outer preform body 232, may allow for ease of assembly of the preform assembly 220. For example, the body 242 of the inner preform 240 and body 232 of the outer preform 230 may not touch throughout the sidewalls 248, 250 and/or the closed ends 236, 226 of the respective preforms. By avoiding contact, issues with tolerance stack-up are relatively reduced, as are problems with the bodies 232, 242 of the nested inner preform 240 and outer preform 230 melting together, such as upon reheat during subsequent blow molding processing. However, it is to be appreciated that a release agent may be applied to improve delamination and separation of the inner preform 240 and outer preform 230 during or after the blow molding process.

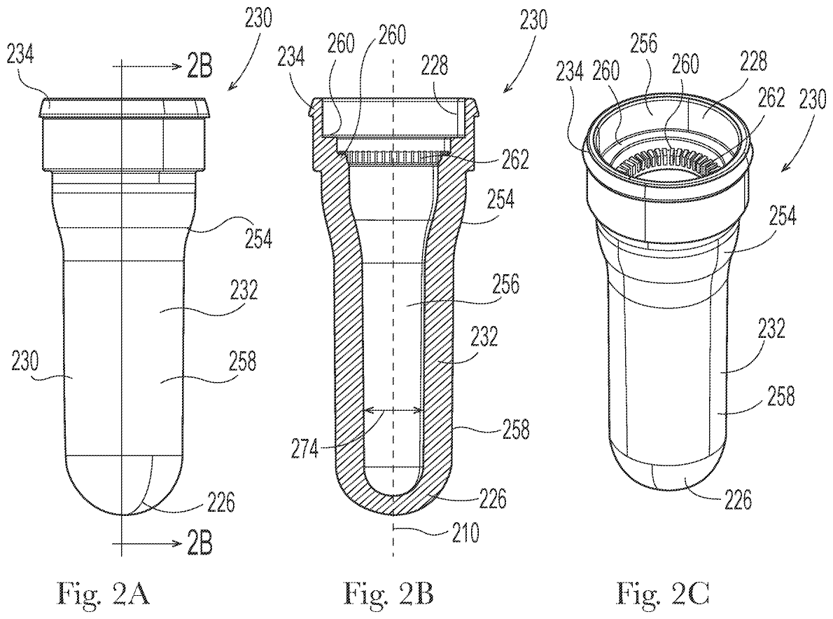

Referring to FIGS. 2A-2C, the outer preform 230 may have an outer preform finish 234. The finish 234 of the outer preform 230 may be larger in diameter than the outer preform body 232. The outer preform 234 finish may be manufactured such as disclosed in U.S. Pat. Nos. 6,019,252; 6,971,530; 7,303,087; and 7,028,866. The body 232 of the outer preform 230 may be substantially uniform or may taper inwardly as the outer preform body 232 extends from the open end 228 to the closed end 226. The body 232 of the outer preform 230 may have a transition zone 254 adjacent to the finish or along the body 232 between the open end 228 and the closed end 226. The transition zone 254 may provide for a reduction in diameter, and particularly a monotonic reduction in diameter, between the underside of the finish and the balance of the body. The outer preform 230 may have an outer preform inner diameter 274 of from about 6 mm to about 30 mm and/or from about 8 mm to about 20 mm and/or from about 11 mm to about 15 mm.

The outer preform may include an outer preform inner surface 256 and an outer preform outer surface 258. The outer preform inner surface 256 may include one or more an inner surface steps 260. The one or more inner surface steps 260 may be substantially perpendicular to a preform longitudinal axis 210 or at an angle to the preform longitudinal axis 210. If the inner surface 256 defines more than one inner surface step 260, each step may be different or the same with respect to the longitudinal axis 210. The inner surface step 260 may be configured to receive one or more inner preforms. Stated another way, the inner preform may be disposed on the inner surface step 260 when the inner preform 240 and the outer preform 230 are assembled, such as being nested with one another. The inner surface 256 of the outer preform 230 may define one or more notches 262.

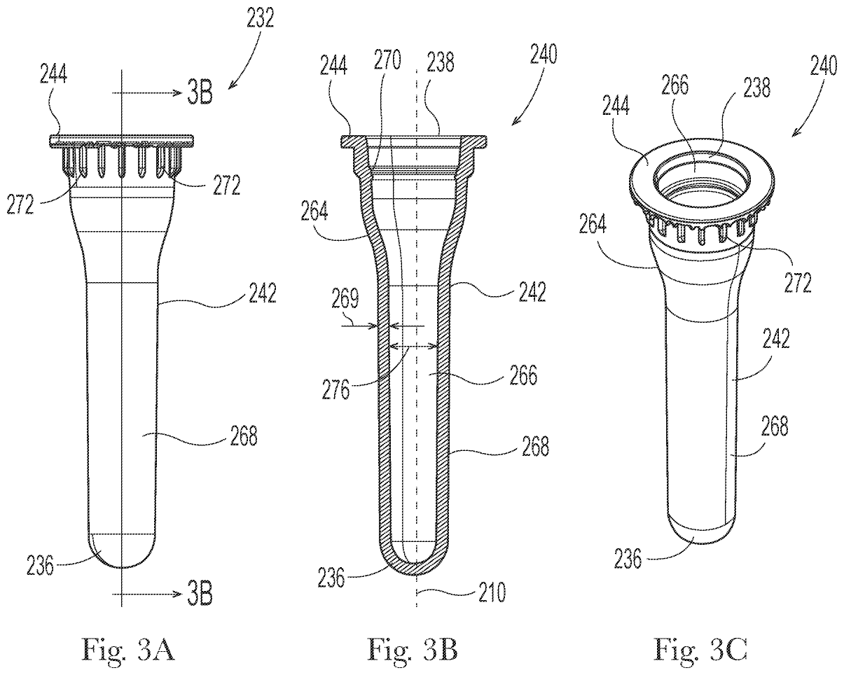

Referring to FIGS. 3A-3C, the inner preform 240 may have an inner preform finish 244. The finish 244 of the inner preform 240 may be larger in diameter than the inner preform body 242. The body 242 of the inner preform 240 may be substantially uniform or may taper inwardly as the inner preform body 242 extends from the open end 238 to the closed end 236. The body 242 of the inner preform 240 may have a transition zone 264 adjacent to the finish or along the body 242 between the open end 238 and the closed end 236. The transition zone 264 may provide for a reduction in diameter between the underside of the finish and the balance of the body. The inner preform 240 may have an inner preform inner diameter 276 of from about 2 mm to about 25 mm and/or from about 5 mm to about 12 mm and/or from about 7 mm to about 10 mm.

The inner preform 240 may include an inner preform inner surface 266 and an inner preform outer surface 268. The inner preform 240 may include an inner preform wall thickness 269, which is the distance measured perpendicular to the longitudinal axis 210 of the preform between the inner surface 266 and outer surface 268. The inner preform inner surface 266 may include one or more an inner surface steps 270. The one or more inner surface steps 270 may be substantially perpendicular to a preform longitudinal axis 210 or at an angle to the preform longitudinal axis 210. If the inner preform inner surface 266 defines more than one inner surface step 270, each step may be different or the same with respect to the longitudinal axis 210. The inner surface step 270 may be configured to receive one or more inner preforms. Stated another way, an inner preform may be disposed on the inner surface step 270 when multiple inner preforms are assembled, such as being nested with one another. It is to be appreciated that the inner preform may not include any steps.

The inner preform outer surface 268 may define one or more ribs 272. The ribs 272 may provide for concentric alignment of the inner preform 240 and outer preform 230. The ribs 272 may also aid in resisting unintended distortion and/or expansion of the inner preform 240 if the plural preform assembly 220 is later pressurized for use as an aerosol dispenser. Upon inserting the inner preform 240 into the outer preform 230, the ribs 272 may radially contact and engage the inner surface of the outer preform 230. The ribs 272 may be unequally or equally, circumferentially spaced about the preform. In the longitudinal direction, the ribs 272 may taper inwardly, corresponding to the transition of the preform and may provide for monotonically reduced diameter as the distal end of the preform is approached. The taper may provide the benefit of a funnel effect so that the inner preform 240 and outer preform 230 are concentric upon nesting. While the ribs 272 have been illustrated as being identically radially oriented, some or all of the ribs 272 may be diagonally oriented relative to the longitudinal axis and or circumference.

The one or more notches 262 of the outer preform 230 may be complementary to the one or more ribs 272 of the inner preform 240. The one or more notches 262 may engage the one or more ribs 272. Such engagement of the one or more ribs 272 and the one or more notches 262 may reduce undesired spinning of the inner preform 240 and outer preform 230 relative to each other during transport of the plural preform assembly and/or the blow molding process and/or the welding process.

It is to be appreciated that the one or more notches 262 may be disposed on the inner preform 240 and the one or more ribs 272 disposed on the outer preform 230. Alternatively, both the inner preform 240 and outer preform 230 may have one or more ribs 272 which engage the other preform. Further, either or both preforms may also have one or more notches that are complementary and that engage the other preform.

It is also to be appreciated that the inner preform 240 and/or the outer preform 230 may optionally be threaded. The threads may be external or internal to the preform. The threads may be used to secure one preform to another or to accept other complementary components such as a valve assembly as described in US Patent Publication Nos. 2018/0043603 and 2018/0043604.

The inner preform 240 and outer preform 230 may be joined together. The inner preform 240 and outer preform 230 may be permanently joined together so that separation of the nested preforms 230, 240 does not occur without unintended damage to either the inner preform 240 or outer preform 230. Alternatively, the inner preform 240 and outer preform 230 may be separably joined together so that the inner preform 240 and outer preform 230 can be separated, but remain nested during ordinary manufacturing, shipping, and storage.

Nesting and joining of the inner preform 240 and outer preform 230 may be accomplished with a friction fit. A friction fit occurs due to radial interference between at least a portion of the inner preform 240 and at least a portion of the outer preform 230. The friction fit is configured to cause the inner preform 240 and outer preform 230 to remain in position and nested during processing, such as until and through the blow molding process. Blow molding occurs while the preforms 230, 240 are nested, so that a bag in container results. The friction fit may occur between any portion of the inner preform 240 and outer preform 230. For example, the friction fit may occur between, the finish 244 of the inner preform 240 and finish 234 of the outer preform 230. A friction fit provides the benefit that a separate material, such as adhesive, is not necessary to maintain the inner preform 240 and the outer preform 230 in a nested configuration. A friction fit also provides the benefit that a mechanical interlock, such as a bayonet fitting or screw thread is not needed to maintain the nested configuration. A mechanical interlock generally adds to the injection molding cost and requires a separate operation to index and join the inner preform 240 and outer preform 230. Thus, joining materials and mechanical interlocks may be advantageously avoided and omitted with the present invention, while retaining the advantages of nesting.

The inner preform 240 and/or the outer preform 230 may include one or more channels. The channels may provide for charging the container with propellant and/or product, which may occur after the inner preform and the outer preform are blow molded.

Each of the inner preform 240 and the outer preform 230 may be made from polyethylene terephthalate (PET), polyethylene furanoate (PEF), polyester, nylon, polyolefin (such as PP and PE), EVOH, or mixtures thereof. Each of the inner preform 240 and the outer preform 230 may include at least about 90% by weight PET or at least about 95% by weight PET or at least about 98% by weight PET. The inner preform 240 and the outer preform 230 may be made such that the only polymer is PET. It is to be appreciated that additives, such as colorants, may be used to manufacture the preforms. For example, the outer preform may be made from a PET such as DAK Laser+C (C60A) with an intrinsic viscosity of 0.83, and the inner preform may be made from a PET such as Plastipak PPK 60C with an intrinsic viscosity of 0.60. The intrinsic viscosity is determined by ASTM D4603, Standard Test Method for Determining Inherent Viscosity of Poly(Ethylene Terephthalate) (PET) by Glass Capillary Viscometer.

The plural preform assembly 220 may be blow molded simultaneously into an article. The plural preform assembly 220 may be blow molded such that the inner preform and the outer preform are nested and co-blown, or, stated another way, concurrently blown. The ability to concurrently blow the inner preform and the outer preform in a single step may relatively reduce manufacturing costs and simplify assembly the article, such as an aerosol dispenser. The plural preform assembly may be blow molded by an injection blow molded (IBM) process or an injection stretch blow molded (ISBM) process.

For example, a concurrently blow molded article, such as a container, may be produced from Polyethylene Terephthalate (PET) or PET co-polymer, referred to herein collectively as PET, using an injection stretch blow molding (ISBM) process. PET is typically a crystallizable material where the resultant article properties are subject to the amount of crystallinity that is produced during the blow molding operation. In the ISBM process, the PET is mechanically crystallized by the stretching of the preform and strain hardening of the polymer. For example, in a two-step ISBM process, generally, strain is applied in the axial direction with the stretch rod and in the hoop direction with internal process, such as air pressure or other fluid pressure, which may provide a relatively higher degree of crystallinity versus other blow molding processes. In the stretching process, the polymer chains are uncoiled and aligned in the direction of the applied strain resulting in densification and subsequent crystal growth. This orientation process yields very small crystallites (lamellae) that not only provide strengthening at the molecular level but are relatively aligned due to the stretching process. The long polymer chains entangle into multiple lamella as well as exist in amorphous regions between the crystallites. These fine crystalline domains produced by stretching may be small enough to not scatter visible light thus yielding a transparent article. As the polymer is stretched to higher levels of strain hardening, the stresses in the article eventually exceed the strength of the material and may lead to fracturing (stress whitening). Preforms are specifically designed for the ISBM process to provide stretching to the point of strain hardening to improve the crystallinity and physical properties of the resultant article while not exceeding the strength of the material causing fractures.

The physical and chemical nature of the preform material, such as PET, will influence the strain hardening behavior for a given set of blow molding process conditions. As the molecular weight of the material increases, the entanglement may become more effective and lead to strain hardening at lower levels of stretching. Conversely, higher comonomer levels in the material, such as PET, structure may delay the onset of strain hardening and require higher levels of stretching to achieve an equivalent level of strain hardening. The preform design for a given article must be adjusted to provide optimal stretching for the specific materials used along with the corresponding process conditions.

To achieve the desired characteristics of the article, such as wall thickness, orientation, and crystallinity, and to successfully co-blow mold the plural preform assembly 220, the inner preform and the outer preform may have certain properties, such as intrinsic viscosity. It has been found that differing the intrinsic viscosity of the inner preform and the outer preform may allow for relatively improved blow molding processing and characteristics of the resulting article. The intrinsic viscosity of the inner preform may be less than the intrinsic viscosity of the outer preform. The outer preform may have an intrinsic viscosity of from about 0.7 to about 1 and/or from about 0.8 to about 0.9 and/or from about 0.8 to about 0.85. The inner preform may have an intrinsic viscosity of from about 0.5 to about 0.7 and/or from about 0.55 to about 0.65 and/or from about 0.58 to about 0.6. The difference in intrinsic viscosity between the inner preform and the outer preform may be from about 0.2 to about 0.3 and/or from about 0.22 to about 0.27. The inner preform intrinsic viscosity may be from about 50% to about 80% of the outer preform intrinsic viscosity. For example, the inner preform intrinsic viscosity may about 70% of the outer preform intrinsic viscosity.

During the blow molding process, the intrinsic viscosity of the preform may drive the amount of strain hardening that the preform may undergo. For example, articles from under-stretched outer preforms may have relatively reduced physical properties such as orientation and crystallinity. Articles from over-stretched inner preforms may also have relatively reduced physical properties such as surface fracturing. Generally, a higher intrinsic viscosity allows for strain hardening at a relatively lower amount of stretching and a lower intrinsic viscosity allows for strain hardening at a relatively higher amount of stretching. A lower intrinsic viscosity generally delays strain hardening until a relatively greater amount of stretch is reached. Depending on the desired properties, the intrinsic viscosity may be selected for each of the inner preform and the outer preform. Further, the inner diameter of the preform may be selected to control the amount of stretch that the preform undergoes in the blow molding process based on the diameter of the mold. The amount of stretch that the preform will undergo during the blow molding process may be determined based on the mold. The intrinsic viscosity of each preform may then be optimized based on the amount of stretch that the preform will undergo during the molding process and the desired properties of the blow molded article. Generally, the preform that is farthest from the longitudinal axis 210 will have the higher intrinsic viscosity and the preform that is closest to the longitudinal axis 210 will have the lower intrinsic viscosity to achieve the desired strain hardening in the article. For example, for a plural preform assembly 220 including a first, inner preform, a second, intermediate preform, and a third, outer preform, the intrinsic viscosity of the inner preform may be less than the intrinsic viscosity of at least one of the intermediate preform and the outer preform and the intrinsic viscosity of the outer preform may be greater than at least one of the intrinsic viscosity of the inner preform and the intermediate preform.

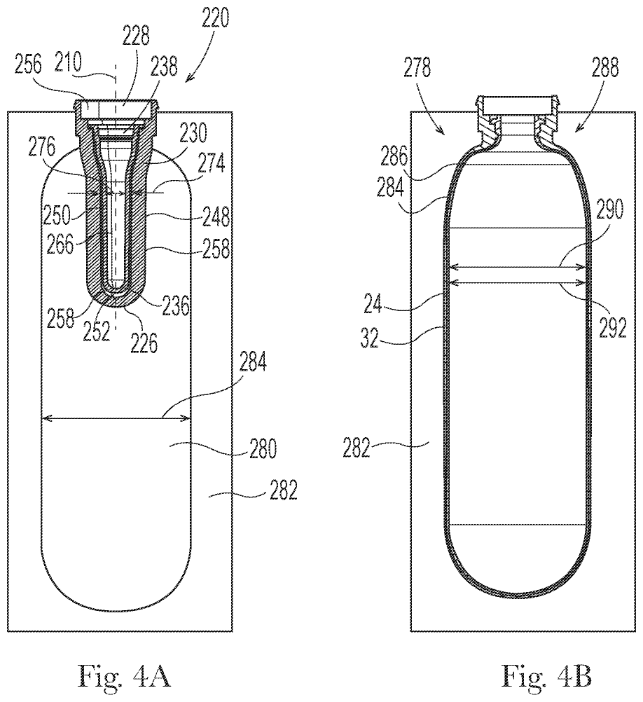

As illustrated in FIG. 4A, a plural preform assembly 220 may be provided. Such as previously described, the plural preform assembly 220 may include two or more preforms. As illustrated in FIG. 4A, the plural preform assembly 220 may include an outer preform 230 and an inner preform 240. The outer preform 230 may include an outer preform open end 228 and an outer preform closed end 226 longitudinally opposed thereto, an outer preform sidewall 248 joining the outer preform open end 228 and the outer preform closed end 226. The outer preform 230 may also include an outer preform inner surface 256 and an outer preform outer surface 258. The inner preform 240 may be at least partially disposed in the outer preform 230. The inner preform 240 may include an inner preform open end 238 and an inner preform closed end 236 longitudinally opposed thereto. An inner preform sidewall 250 joins the inner preform open end 238 and the inner preform closed end 236. The inner preform 240 may include an inner preform inner surface 266 and an inner preform outer surface 258. The intrinsic viscosity of the inner preform 240 and the outer preform 240 are different. For example, the intrinsic viscosity of the inner preform 240 may be less than the intrinsic viscosity of the outer preform 230.

The inner preform and the outer preform may be joined prior to being loaded into the mold or after being loaded into the mold. The inner and outer preforms may be permanently joined or separably joined.

The plural preform assembly 220 may be loaded into a mold cavity 280 of a mold 282. Upon blow molding the plural preform assembly 220 may expand into the mold cavity 280. The plural preform assembly 220 stretches and essentially fills the mold cavity. The amount of stretch that the plural preform assembly 220 undergoes is based on the dimension of the mold cavity. For the biaxial stretching present when a preform undergoes an injection blow molding process, the amount of orientation may be represented by the hoop stretch, the axial stretch, and the planar stretch.

The hoop stretch describes the radial stretching of the preform to the final diameter of the formed article, which may be a container. A hoop stretch ratio is calculated by dividing the inner diameter of the outer article by the inner diameter of the preform used to form the article. Although the hoop stretch may be described from the outer diameters or even be represented as a continuum through the thickness of the parts, the hoop stretch that is described by using the inner diameters represents the maximum hoop stretch for the preform and article pair. The axial stretch describes the axial stretching of the preform to the longer length of the formed article. The axial stretch ratio is calculated by dividing the cross sectional surface length of the article by the cross sectional surface length of the preform that forms that portion of the article. For axially-symmetric containers and preforms, the half lengths of the cross sections are commonly used. The planar stretch is a combination of the hoop stretch and the axial stretch and describes the biaxial stretching of the preform into the final article. The planar stretch is calculated by multiplying the hoop stretch ratio with the axial stretch ratio.

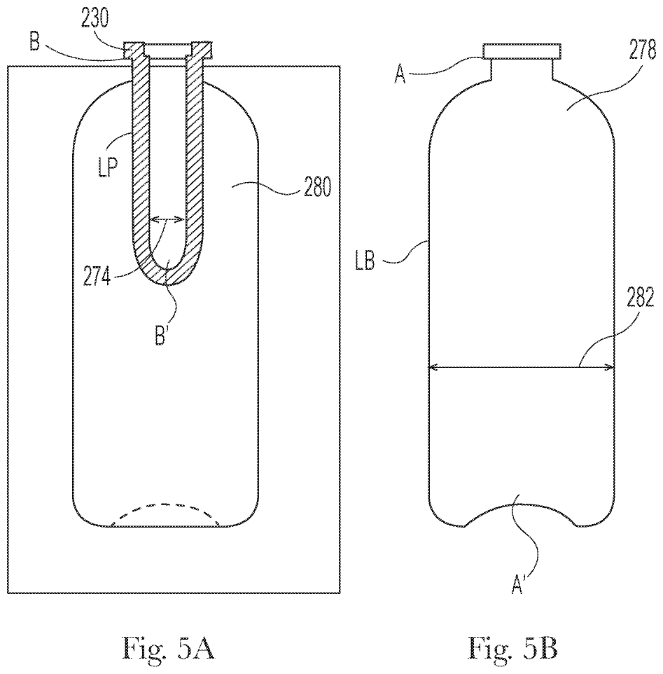

For example, with reference to FIGS. 5A and 5B, the blow molding process may include, a mold cavity 280 into which a preform 230 may be loaded and blow molded into an article 278. The preform 230 may be blow molded into a container having a substantially circular cross-section. Thus, the hoop stretch ratio is calculated by dividing the inner article diameter 282 by the inner diameter 274 of the preform 230. The axial stretch ratio is calculated by dividing the cross sectional surface half-length LB of the article 278 by the cross sectional surface half length LP of the preform 230. The cross sectional surface half length LB of the article 278 is measured along the surface of the article as the linear length of the line connecting points A to A′, such as illustrated in FIG. 4B. The cross sectional surface half length LP of the preform 230 is measured along the surface of the preform as the linear length of the line connecting points B to B′, such as illustrated in FIG. 4A.

A plural preform assembly also has stretch ratios. Referring to FIGS. 4A and 4B, each of the inner preform 240 and outer preform 230 may be blow molded into a respective article 278. The article 278 may include inner container 284, which may be referred to as a bag, and an outer container 286, which may be referred to as a bottle or container. The inner container 284 may be blow molded from the inner preform 240 and the outer container 286 may be blow molded from the outer preform 230. It is to be appreciated that the number of blow molded containers within an article will depend on the number of preforms of the plural preform assembly. For example, a plural preform assembly 220 may include an inner preform 240 and an outer preform 230. The inner and outer preform may be co-blow molded to form an article referred to herein as a bag in container assembly 288, such as illustrated in FIG. 4B. The bag in container assembly 288 may include a bag and a container. The bag 24 may be formed by the blow molded inner preform and the container 32 may be formed by the blow molded outer preform. The article 278 and the bag in container assembly 288 may be configured to hold product therein, for subsequent dispensing by a user. For example, the bag in container assembly may be used as an aerosol dispenser, such as described herein. The container may have an intrinsic viscosity of from about 0.7 to about 1 and/or from about 0.8 to about 0.9 and/or from about 0.8 to about 0.85. The bag may have an intrinsic viscosity of from about 0.5 to about 0.7 and/or from about 0.55 to about 0.65 and/or from about 0.58 to about 0.6.

Each of the inner preform and the outer preform may have a hoop stretch ratio. The inner preform inner diameter 276 may be 7 mm and the inner container 284 inner diameter 290 may be 58 mm, and, thus, the inner preform hoop stretch ratio will be about 8. Similarly, the outer preform inner diameter 274 may be about 11 mm and the outer container 286 inner diameter 292 may be 58 mm, and, thus, the outer preform hoop stretch ratio will be about 5. The dimensions of the preform may be taken at a desired location along the body of the preform and the location of the dimension of the container may be taken at the location where the desired location of the preform will be blown to. Stated another way, the hoop stretch ratio is the ratio of the dimension of the container or article at a specified location to the dimension of the preform prior to blow molding but that will coincide with location of the dimension of the container once the preform is blow molded. The inner preform hoop stretch ratio may be greater than the outer preform hoop stretch ratio. The inner preform hoop stretch ratio may be from about 4 to about 10 and/or from about 5 to about 8, and the outer preform hoop stretch ratio may be from about 2 to about 6.

The plural preform assembly may have a plural preform hoop stretch index. The plural preform hoop stretch index is the ratio of an inner preform hoop stretch ratio to an outer preform hoop stretch ratio. For example, as illustrated in FIG. 4A, the plural preform assembly may include an inner preform 240 and an outer preform 230. The inner preform may have an inner preform hoop stretch ratio of about 8 and the outer preform may have an outer preform hoop stretch ratio of about 5, and thus, the plural preform assembly hoop stretch index will be about 1.6. The plural preform assembly hoop stretch index may be taken between any two preforms. The plural preform assembly hoop stretch index may be greater than about 1.1 or greater than about 1.3 or greater than about 1.4 or greater than about 1.6 or greater than about 1.8.

For concurrently blow molded containers, the plural nested preforms used to mold a single multilayer article, such as a container, may lead to higher stretch ratios for the smaller diameter inner preforms. The innermost preform of a given plural preform assembly will have a maximum inner diameter limited by the inner diameter of the outer preform, the wall thickness of the inner preform, and any gap present between the plural preform pair. This geometry generally results in a hoop stretch ratio that is larger for the inner preform than for the outer preform of a given nested preform pair. In a similar manner, the axial stretch ratio for the inner preform generally will be larger than for the outer preform since the cross sectional surface half length of the innermost preform for a given pair will be shorter than the outer preform.

It is also to be appreciated that each of the inner preform and the outer preform of a plural preform assembly have an axial stretch ratio and undergo planar stretch. These values may be determined as set forth herein for each preform.

At the conclusion of the blow molding process, the article 278 or container or bag in container assembly 288 may be removed from the mold cavity 280. The article 278 or container or bag in container assembly 288 may be subject to further processes, such as being filled with fluid or having additional components added thereto.

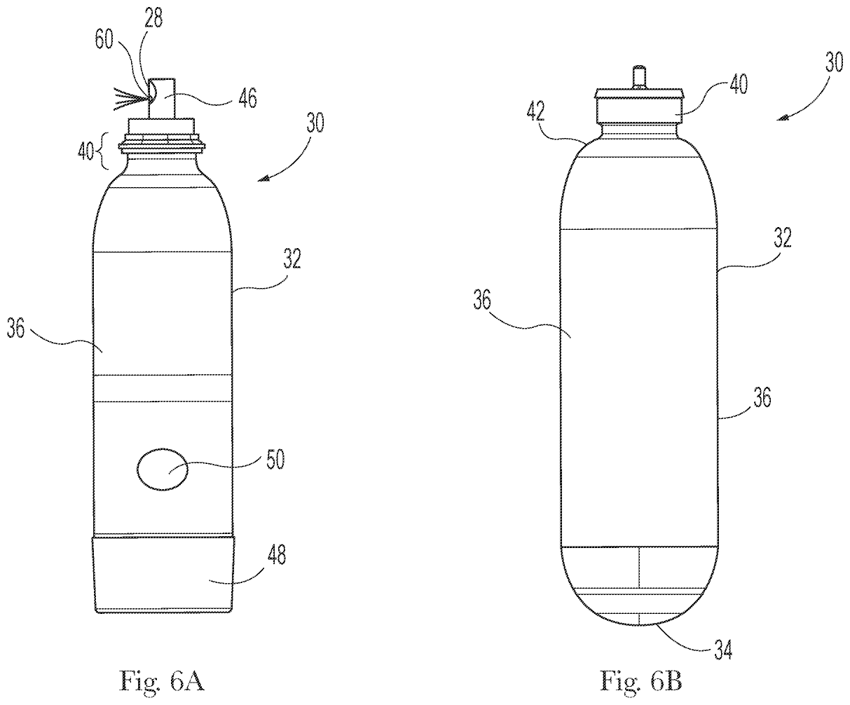

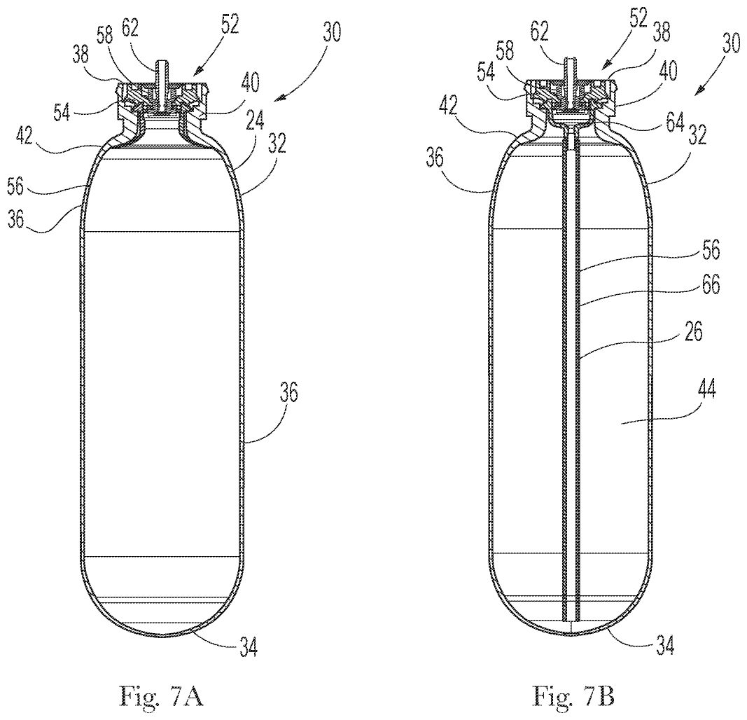

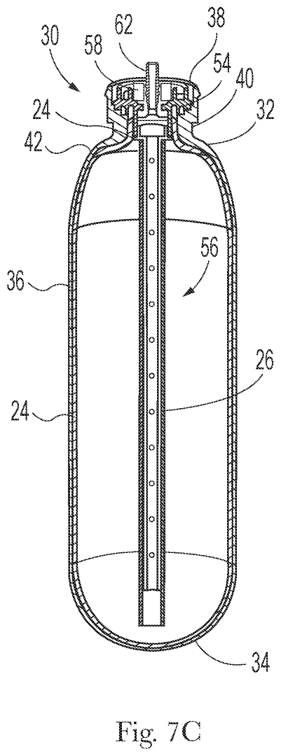

The aforementioned process may be used to manufacture a bag in container assembly that may be used as an aerosol dispenser. With reference to FIGS. 6A, 6B, 7A, and 7B, an aerosol dispenser 30 may include a container 32, a valve assembly 52 (also referred to herein as a valve), a product delivery device 56, and an actuator 46. The container 32 may include a base cup 48 joined thereto and indicia 50 disposed on, for example, the sidewalls 36 of the container 32. The valve assembly 52 may be joined to a portion of the container 32. By joined includes directly or indirectly joined. Joined includes separably joined and fixedly joined. Joined includes both mechanical attachment, such as by screws, bolts, interference fit, friction fit, welding, and integrally molding, and chemical attachment, such as by adhesive or the adhesive properties inherent in the materials being attached. The valve assembly 52 may be joined to the container such that a portion of the valve assembly 52 is disposed within the container. The product delivery device 56 may be joined to at least one of a portion of the container 32 and a portion of the valve assembly 52 and the product delivery device may be in fluid communication with the actuator 46.

With reference to FIGS. 6A, 6B, 7A, 7B, and 7C, the container 32 may be used to hold product and/or propellant. The container 32 may be any shape that allows product and/or propellant to be held within the interior of the container. For example, the container may be peanut-shaped, oval-shaped, or rectangular-shaped. It is to be appreciated that the container 32 may be molded, which allows for any number of shapes to be used. The container 32 may be longitudinally elongate such that the container has an aspect ratio of a longitudinal dimension to a transverse dimension, such as diameter. The aspect ratio may be greater than 1, equal to 1, such as in a sphere or shorter cylinder, or an aspect ratio less than 1. The containers 32 may be cylindrical.

The container 32 may include a closed bottom 34, one or more sidewalls 36, and a neck 40. The one or more sidewalls 36 may extend between the closed bottom 34 and the neck 40. The sidewalls 36 define the shape of the container 32 walls. A shoulder 42 may be included between the neck 40 and the one or more sidewalls 36. The neck 40 of the container 32 may define an opening 38. The opening 38 may be opposite the bottom 34 of the container 32. The neck 40 and/or shoulder 42 may have a uniform or varying thickness or crystallinity in order to achieve a desired strength in these regions of the container 32.

The bottom 34 of the container 32 may be configured for resting on horizontal surfaces such as shelves, countertops, tables etc. The bottom 34 of the container 32 may include a re-entrant portion or base cup 48. The base cup 48 may be joined to the bottom 34 of the container 32 and may aid in reinforcement of the bottom 34 and/or may allow the container to rest on horizonal surfaces. The base cup 48 may be mechanically joined, such as by threads or clamps, or chemically joined, such as by adhesives. To minimize the adverse impact of the base cup to recyclability, the base cup 48 may be fixedly joined to the container 32 and made from the same material as the container. The base cup may also be removably joined to the container 32 such that the base cup separates from the container. The container 32 may not include a base cup and may be configured to sit on at least a portion of the bottom 34. Suitable shapes of the bottom 34 include petaloid, champagne, hemispherical, seat-ring, or other generally convex and/or concave shapes. Each of these shapes of the bottom 34 may be used with or without a base cup 48.

The container 32 may be polymeric. The container 32 may include polyethylene terephthalate (PET), polyethylene furanoate (PEF), polyester, nylon, polyolefin (such as PP and PE), EVOH, polyethylene naphthalate (PEN), or mixtures thereof. The container may be a single layer or multi-layered. The container 32 may be injection molded or further blow molded, such as in an injection-stretch blow molding process or an extrusion blow molding process. It is to be appreciated that the material, such as PET, described herein may be virgin material or recycled material.

The container 32 may be axisymmetric as shown, or, may be eccentric. The cross-section may be square, elliptical, irregular, etc. Furthermore, the cross section may be generally constant as shown, or may be variable. For a variable cross-section, the container may be, for example, barrel shaped, hourglass shaped, or monotonically tapered. The container may be a single layer or multi-layered.

The container 32 may range from about 6 cm to about 40 cm, or from about 8 cm to about 20 cm in height, taken in the axial direction. The container 32 may have a cross-section perimeter or diameter, if a round cross-section is selected, from about 3 cm to about 30 cm, or from about 4 cm to about 10 cm. The container may have a volume ranging from about 40 cubic centimeters to about 50,000 cubic centimeters exclusive of any components therein, such as a product delivery device 56.

At 21° C., the container 32 may be pressurized to an internal gage pressure of about 100 kPa to about 1500 kPa, or from about 110 kPa to about 1300 kPa, or from about 115 kPa to about 490 kPa, or about 270 kPa to about 420 kPa using a propellant. An aerosol dispenser 30 may have an initial propellant pressure of about 1500 kPa and a final propellant pressure of about 120 kPa, an initial propellant pressure of about 900 kPa and a final propellant pressure of about 300 kPa, or an initial propellant pressure of about 500 kPa and a final propellant pressure of 0 kPa, including any values between the recited ranges.

The container may be made from a material including polyethylene terephthalate (PET). The majority of the material from which the container may be made is PET, though the container material may also include low-level additives to facilitate processing. For example, the PET material comprising the container may include low-level additives such as a re-heat additive (e.g. carbon black), colorants/opacifiers (including on the container and part of the material of the container), UV additives, anti-static agents, and mold-release agents. The container material may include at least about 90% by weight PET, at least about 92.5% by weight PET, at least about 95% by weight PET, at least about 98% by weight PET. The percent weight of PET does not include decoration that may be disposed on the container.

The container may be configured to contain the product and the propellant. The propellant may include hydrocarbons, compressed gas, such as nitrogen and air, hydro-fluorinated olefins (HFO), such as trans-1,3,3,3-tetrafluoroprop-1-ene, and mixtures thereof. Propellants listed in the US Federal Register 49 CFR 1.73.115, Class 2, Division 2.2 may be acceptable. The propellant and/or the product may be non-flammable. The propellant may be condensable. A condensable propellant, when condensed, may provide the benefit of a flatter depressurization curve at the vapor pressure, as product is depleted during usage. A condensable propellant may provide the benefit that a greater volume of gas may be placed into the container at a given pressure. Generally, the highest pressure occurs after the aerosol dispenser is charged with product but before the first dispensing of that product by the user.

The valve assembly 52 may be in fluid communication with the actuator 46. The actuator 46 may include an orifice cup 28 that defines a nozzle 60. The nozzle 60 directs product out of the aerosol dispenser and into the environment or onto a target surface. The nozzle may be configured in various different ways depending upon the desired dispensing and spray characteristics.

The actuator 46 may be engaged by a user and is configured to initiate and terminate dispensing of the product and/or propellant. Stated another way, the actuator provides selective dispensing of the product and/or propellant. The actuator 46 may be depressible, operable as a trigger, push-button, and the like, to cause release of a product from the aerosol dispenser 30.

The orifice cup 28 is typically a high-rigidity plastic material with precise channeling required to ensure the nozzle operates as desired. The orifice cup 28 defines the nozzle 60. The nozzle generally determines the spray-pattern achieved when the aerosol dispenser is in the dispensing configuration and may include such variations as the dispersion of the spray, the droplet-size of the spray, multiple-streams, and the like.

The actuator 46 may include a connector such as a male or female connector, snap-fit connector, or the like to secure the actuator to the container. The actuator may be joined, such as separably joined, to the container or the valve assembly. The actuator may be made from a material including polypropylene (PP). The actuator may be made from a material including PET. The actuator may include polyethylene furanoate (PEF), polyester, nylon, polyolefin (such as PE), EVOH, or mixtures thereof.

It is to be appreciated that to dispense product, the aerosol dispenser does not need to include an actuator. The product and/or propellant may be dispensed from the stem.

The product delivery device 56 may be used to contain and/or provide for delivery of product and/or propellant from the aerosol dispenser 30 upon demand. Suitable product delivery devices 56 include a bag 24 or a dip tube 26, such as illustrated in FIGS. 7A and 7B. The product delivery device 56 may include polyethylene terephthalate (PET), polypropylene (PP), polyethylene furanoate (PEF), polyethylene naphthalate (PEN), polyester, nylon, polyolefin, EVOH, HDPE (high-density polyethylene), LDPE (low density polyethylene), LLDPE (linear low density polyethylene), or mixtures thereof. It is to be appreciated that the PET included in the product delivery device may have different properties, such as, for example, intrinsic viscosity, than the PET included in the container. Where the product delivery device includes a bag, the bag 24 may be disposed within the container 32 and be configured to hold a product therein, such as illustrated in FIG. 7A. Propellant may be disposed within the container 32 and between the container and the bag 24. A portion of the bag 24 may be joined to at least one of the container 32 and a portion of the valve assembly 52, such as the valve body 54. The bag 24 may be positioned between the container 32 and the valve body 54. The bag 24 may be joined to the valve body 54. The bag 24 may include a lubricant.

As illustrated in FIG. 7B, the dispenser may include dip tube 26. The dip tube 26 may include a tube 66 and a dip tube adaptor 64. The dip tube adaptor 64 may be disposed within the container 32. The dip tube adaptor 64 may engage a portion of the neck 40. The dip tube 26 may be joined to the dip tube adaptor 64 and extend from the dip tube adaptor 64 toward the bottom 34 of the container 32. It is to be appreciated that the dip tube 26 may be joined to a portion of the valve assembly, such as the valve body 54. The dip tube 26 and/or the dip tube adaptor 64 may be joined to the valve body 54 prior to being disposed within the container. The dip tube 26 and/or the dip tube adaptor 64 may be disposed within the container and then subsequently joined to a portion of the container and/or the valve body 54. The tube 66 may be joined to the dip tube adaptor 64.

The product delivery device 56 may include a metering device for dispensing a pre-determined, metered quantity of product. The product delivery device 56 may include, for example, an inverting valve such as a valve including a ball therein to alter the path of product flow. The product delivery device 56 may include a dip tube disposed in a bag. The product delivery device 56 may be polymeric.

Referring to FIG. 7C, the product delivery device 56 may include a dip tube 26 and a bag 24. The dip tube may be disposed within the bag 24. The dip tube 26 may include one or more orifices through which product may flow. A portion of the dip tub 26 may be joined to a portion of the bag or a portion of the valve assembly 54. A portion of the dip tube 26 may be joined to a portion of the valve body 54. The dip tube 26 may be joined to a portion of the valve body 54 by friction fit, snap fit, chemical attachment, such as by adhesive, or mechanical attachment, such as by a screw or nail. Prior to the valve assembly 52, the dip tub 26 and/or the bag 24 being joined to the container 32. The bag and the container may be formed by a concurrently blown plural preform, as described herein, and the dip tube may be disposed within the bag.

The container 32, and/or optionally the product delivery device 56 may be transparent or substantially transparent. This arrangement provides the benefit that the consumer knows when product is nearing depletion and allows improved communication of product attributes, such as color, viscosity, etc. Also, indicia disposed on the container, such as labeling or other decoration of the container, may be more apparent if the background to which such decoration is applied is clear. Labels may be shrink wrapped, printed, etc., as are known in the art.

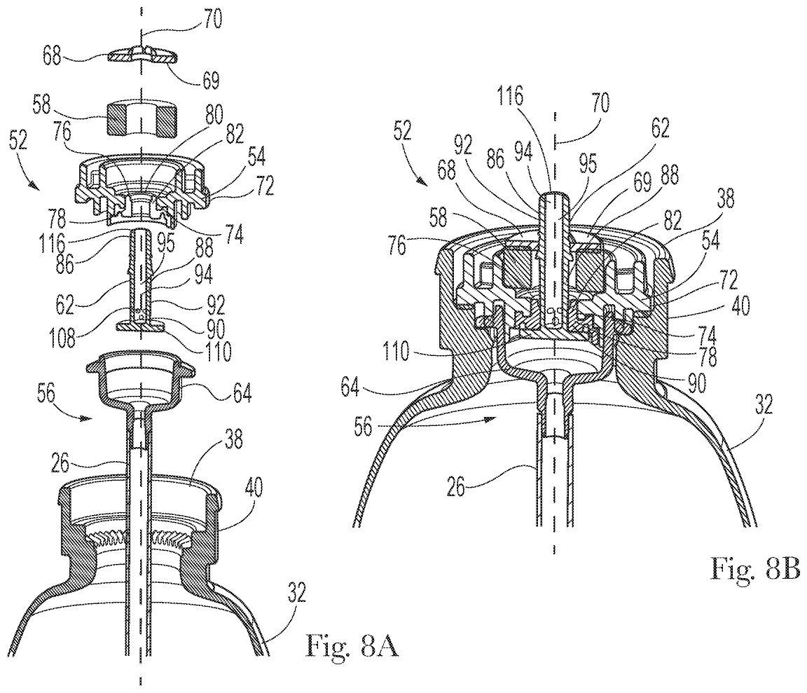

The product delivery device 56 may be positioned between the valve assembly 52 and the container 32. The product delivery device 56 and the valve assembly 52 may be disposed, at least in part, in the neck of the container 32. For example, such as illustrated in FIGS. 8A and 8B, the dip tube 26, including the tube 66 and the dip tube adapter 64 may be disposed in the container such that a portion of the dip tube 26, such as the tube 66, extends into the container and the dip tube adaptor 64 is joined to the neck 40 of the container 32. The valve assembly 52 may be disposed on a portion of the dip tube adaptor and a portion of the neck 40. The dip tube and the valve assembly are in fluid communication. Similarly, a bag 24 may be disposed in the container such that a portion of the bag 24 is joined to the neck 40 of the container 32 and a portion of the bag 24 extends into the container 32. The valve assembly 52 may be disposed on a portion of the bag 24 and a portion of the neck 40. The bag and the valve assembly are in fluid communication.

The container 32 may include a neck 40. The neck 40 may define an opening 38 and be configured to receive a valve assembly 52. The valve assembly 52 may be inserted, at least partially, into the opening 38 of the neck 40 of the container 32, such as illustrated in FIGS. 7A, 7B, and 7C. The valve assembly 52 may include a valve body 54, a valve stem 62, a valve seal 82, and a resilient member 58. At least a portion of the valve assembly 52 may be movable in relationship to the balance of the aerosol dispenser in order to open and close the aerosol dispenser for dispensing and containing product. The valve assembly 52 may be opened due to movement of the valve stem 62 which may be through use of an actuator 46 or through manual or other mechanical depression of the valve stem 62. When the valve 52 is opened, for example, by way of the actuator 46, a flow path is created for the product to be dispensed through a nozzle 60 to ambient or a target surface. The valve assembly 52 may be opened, for example, by selective actuation of the actuator 46 by a user.

A portion of the valve body 54 may be sealed to the neck of the container 32, such as illustrated in FIGS. 7A, 7B, and 7C, to prevent the escape of propellant, product, and the loss of pressurization. The valve body 54 may be sealed to the container 32 utilizing a press fit, interference fit, crimping, solvent welding, laser welding, sonic welding, ultrasonic welding, spin welding, adhesive or any combination thereof, so long as a seal adequate to maintain the pressure results. The valve body 54 may be joined to the container 32 such that at least a portion of the valve body 54 is disposed within the container 32. The valve body 54 may be joined to the container 32 such that the valve body 54 is joined to the opening of the neck and the valve body 54 is disposed on top of the neck.

As illustrated in FIGS. 8A and 8B, the valve body 54 may extend about a longitudinal axis 70. The valve body 54 may include an outer surface 72 and define an inner passageway 74. The outer surface 72 may include the surface positioned farthest from the longitudinal axis 70. The outer surface 72 may extend about the longitudinal axis 70. The inner passageway 74 may include a first passageway opening 76 and a second passageway opening 78 and a passageway surface 80 extending from the first passageway opening 76 to the second passageway opening 78. The passageway surface 80 may substantially surround the longitudinal axis 70.

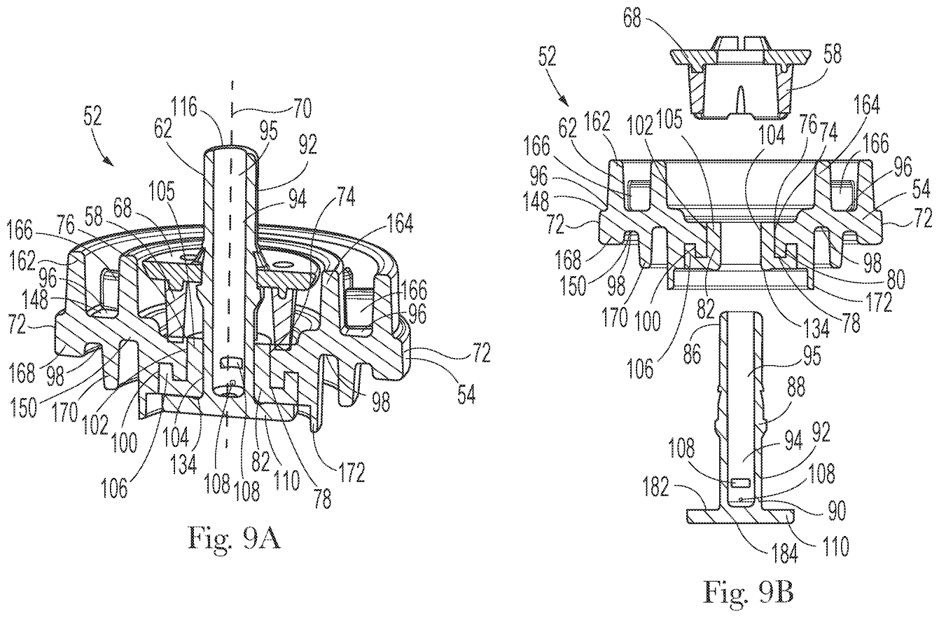

Referring to FIGS. 9A and 9B, the valve assembly 52 may include a valve body 54. The valve body 54 includes an outer surface 72 and an inner passageway 74 extending about a longitudinal axis 70. As previously discussed, the inner passageway 74 includes a first passageway opening 76, a second passageway opening 78, and a passageway surface 80 extending from the first passageway opening 76 to the second passageway opening 78. The valve body 54 may include a first valve body surface 96 and a second valve body surface 98 opposite the first valve body surface 96. The valve body surfaces may extend from the outer surface 72 of the valve body to the inner passageway 74. The valve body surfaces may have any geometry such that the valve body may be joined to the container and an adequate seal may be maintained. As illustrated in FIG. 9A-9B, the surface may include a step portion, also referred to herein as a transition portion, such that the first surface is not continuously planar from the outer surface to the inner passageway.

The valve body 54 may include a valve body cavity 100, such as illustrated in FIGS. 9A and 9B. The valve body cavity 100 is a cavity defined by a portion of the valve body 54 and may be positioned between the inner passageway 80 and the outer surface 72. The valve body cavity 100 may be positioned adjacent to the inner passageway 80 so that a portion of the valve seal 82 may extend from the inner passageway 80 and into the valve body cavity 100. The valve body cavity 100 may extend, either partially or wholly, about the longitudinal axis 70. The valve body cavity 100 may extend from the second valve body surface 98 towards the first valve body surface 96. The valve body cavity 100 may extend from the inner passageway 80 toward the outer surface 72 of the valve body 54. The valve body cavity 100 may be any shape such that a portion of the valve seal may be disposed within at least a portion of the valve body cavity 100.

The valve body cavity 100 may be configured to accept a portion of the valve seal 82. More specifically, a portion of the valve seal 82 may extend from the inner passageway 80 about the second passageway opening 78 and into at least a portion of the valve body cavity 100. The valve seal 82 includes a valve seal first end portion 105 and a valve seal second end portion 106. The valve seal first end portion 105 may be disposed within the inner passageway 80. The valve seal second end portion 106 may be opposite the valve seal first end portion 105. At least a portion of the valve seal second end portion 106 may be disposed within the valve body cavity 100. At least a portion of the valve seal second end portion 106 may be substantially surrounded by the valve body cavity 100. The valve body cavity 100 protects the valve seal second end portion 106 from separating from the valve body 54 under intended operating conditions. The valve body cavity may aid in maintaining the position of the valve seal with respect to the valve body when the dispenser is in use.

As illustrated in FIGS. 9A and 9B, the valve body 54 may include one or more members that extend from at least one of the first valve body surface 96 and the second valve body surface 98. The valve body 54 may include a first brace member 162. The first brace member 162 may be joined to the first valve body surface 96 and extend away from the first valve body surface 96. The first brace member 162 may extend continuously or discontinuously about the inner passageway 74. An actuator or other dispensing component may be joined to a portion of the first brace member 162.

The valve body 54 may include a second brace member 164. The second brace member 164 may be joined to the first valve body surface 96 and extend away from the first valve body surface 96. The second brace member 164 may be positioned between the outer surface 72 and the inner passageway 74 of the valve body 54. The second brace member 164 may extend continuously or discontinuously about the inner passageway 74. An actuator or other dispensing component may be joined to a portion of the second brace member 164.

The second brace member 164 may function to aid in guiding the engagement member 68 and/or the resilient member 58 as the valve stem 62 moves between the sealed configuration, the dispensing configuration, and/or the filling configuration. The second brace member 164 may substantially surround the engagement member 68 and/or the resilient member 58 such that the engagement member 68 may slidably move and the resilient member 58 may move, such as by deflecting or compressing. A gap may be present between the second brace member 164 and the engagement member 68. The engagement member 68 may slidably engage a portion of the brace member 164. For example, the engagement member may comprise a protrusion that slidably engages a ridge within the interior portion of the second brace member to prevent the engagement member from rotating.

The valve body 54 may include one or more ribs. A rib 166 may extend between the first brace member 162 and the second brace member 164. The rib 166 may be joined to at least one of the first brace member 162 and the second brace member 164. As illustrated in FIG. 9A, the rib may be joined to both of a portion of the first brace member 162 and a portion of the second brace member 164. The rib may extend radially between the first brace member 162 and the second brace member 164. The rib 166 may be joined to the first valve body surface 96. The rib 166 may not be joined to the first valve body surface 96 and, thus, a gap may be present between the first valve body surface 96 and the rib 166. The one or more ribs 166 may aid in manufacturing the aerosol dispenser. For example, the one or more ribs 166 may be used to grip the valve body 54 such that the valve body 54 may be moved and/or attached to the container. The one or more ribs 166 may be operatively engaged by processing equipment during the manufacture of the aerosol dispenser. The one or more ribs 166 may allow for welding, such as by spinning, the valve body 54 to the container. The one or more ribs 166 may also provide structural stability to the valve body 54. The one or more ribs 166 may aid in controlling the deformation of the valve body 54 when the aerosol dispenser is subject to relatively high temperatures, for example.

As illustrated in FIGS. 9A and 9B, the valve body 54 may include one or more protrusions that extend from at least one of the first valve body surface 96 and the second valve body surface 98. The valve body 54 may include a first attachment protrusion 168. The first attachment protrusion 168 may be joined to the second valve body surface 98 and extend away from the second valve body surface 98. The first attachment protrusion 168 may extend continuously or discontinuously about the inner passageway 74. The first attachment protrusion 168 may extend continuously or discontinuously about the longitudinal axis 70. The first attachment protrusion 168 may extend from the outer surface 72 of the valve body 54 towards the inner passageway 74. The first attachment protrusion 168 may be configured to be join the valve body to a portion of the neck of the container. The first attachment protrusion 168 may be welded to a portion of the neck of the container. It is to be appreciated that first attachment protrusion may be joined to the neck such as by a press fit, interference fit, crimping, solvent welding, laser welding, sonic welding, ultrasonic welding, spin welding, adhesive, or any combination thereof. The height and width of the first attachment protrusion 168 may be selected to obtain a desired weld between the valve body and the container. Generally, the greater the surface area, the greater the strength of the weld. The first attachment protrusion 168 may include one or more grooves or other surface profile such that gas may pass between a portion of the first attachment protrusion 168 and the neck prior to the valve body being sealed to the container.

As illustrated in FIGS. 9A and 9B, the valve body 54 may include a second attachment protrusion 170. The second attachment protrusion 170 may be joined to the second valve body surface 98 and extend away from the second valve body surface 98. The second attachment protrusion 170 may extend continuously or discontinuously about the inner passageway 74. The second attachment protrusion 170 may extend continuously or discontinuously about the longitudinal axis 70. The second attachment protrusion 170 may extend from the outer surface 72 of the valve body 54 towards the inner passageway 74. The second attachment protrusion 170 may be configured to join the valve assembly to a portion of the neck of the container or a portion of the product delivery device 56. The second attachment protrusion 170 may be welded to a portion of the neck of the container or a portion of the product delivery device 56, such as a bag, dip tube, or dip tube adaptor. It is to be appreciated that second attachment protrusion may be joined to the neck such as by a press fit, interference fit, crimping, solvent welding, laser welding, sonic welding, ultrasonic welding, spin welding, adhesive, or any combination thereof.

The valve body 54 may include a valve skirt 172. The valve skirt 172 may be joined to the second valve body surface 98 and extend away from the second valve body surface 98. The valve skirt 172 may extend continuously or discontinuously about the inner passageway 74. The valve skirt 172 may extend continuously or discontinuously about the longitudinal axis 70. The valve skirt 172 may be positioned between the outer surface 72 and the inner passageway 74 of the valve body 54 or the longitudinal axis 70. The valve skirt 172 may be positioned between the first attachment protrusion 168 and the inner passageway 74 of the valve body 54 or the longitudinal axis 70. The valve skirt 172 may be positioned between the second attachment protrusion 170 and the inner passageway 74 of the valve body 54 or the longitudinal axis 70. The valve skirt 172 may extend from at least one of the first hoop member 140 and the second hoop member 142. As illustrated in FIGS. 9A and 9B, the valve skirt 172 may extend from the second hoop lower surface 150 towards the bottom of the container. The valve skirt may be used to prevent material from interfering with the movement and operation of the valve assembly. It is to be appreciated that the valve skirt may or may not be present, and this may be dependent on the type and geometry of the product delivery device 56.

The valve body 54 may be made of any suitable material. The valve body may be fixedly joined to the container in order to contain the product and/or propellant. A valve body fixedly joined to the container may be made from a material including PET. Generally, the valve body is joined to the container is such a way that the end-user is not capable of removing it. If the end-user (e.g. the consumer) were able to remove the valve-body, the entire product/propellant contents of the dispenser could be released in an unsafe manner. Alternately, the valve body may be connected to the dispenser as a screw-in attachment, such as disclosed in U.S. Patent Publication No. US 2018-0044096, and, optionally, with an anti-rotation feature, such as disclosed in U.S. Patent Publication Nos. US 2019-0077558; US 2019-0077583; US 2019-0077584; and US 2019-0077582.

A valve stem 62 may extend through the inner passageway 74 of the valve body 54. The valve stem 62 provides a product flow path from the interior of the container to the actuator 46 and operatively joins the actuator 46 to the valve assembly 52. The valve stem 62 may be positioned with respect to the valve body 54 in a sealed configuration such that an upper portion 86 of the valve stem 62 extends through the first passageway opening 76 of the valve body 54, a second portion 88 of the valve stem 62 may be substantially surrounded by the passageway surface 80, and a third portion 90 of the valve stem 62 may extend through the second passageway opening 78 of the valve body 54. The valve stem 62 may be moveable with respect to the valve body 54, for example between a sealed or sealing configuration and/or a dispensing configuration and/or a filling configuration. Thus, the valve stem 62 may be positioned in other configurations as the valve stem 62 moves. The valve stem 62 may include an outer stem surface 92 and an inner stem surface 94 opposite the outer stem surface. The inner stem surface 94 may define a channel 95 through which product and/or propellant may flow either out from or into the container. The valve stem 62 may include a dispensing opening 116 that may be used to introduce propellant and/or product into the container or dispense product and/or propellant from the container.

The valve assembly 52 may include an engagement member 68. The engagement member 68 may be joined to a portion of the valve stem 62 such that the engagement member 68 moves as the valve stem 62 moves. The engagement member 68 may extend from the outer stem surface 92 towards the outer surface 72 of the valve body 54. The engagement member 68 may be axisymmetric or non-axisymmetric. The engagement member 68 includes an engagement surface 69. The engagement surface 69 is configured to operatively engage a portion of the resilient member 58. The resilient member 58 may be positioned between the engagement surface 69 and a portion of the valve body 54. When the valve stem 62 is in a sealing configuration, the engagement surface 69 may operatively engage the resilient member 58 such that the resilient member 58 is placed under a desired amount of compression which biases the valve stem 62 to remain in a position such that a seal is maintained. When the valve stem 62 is in a dispensing configuration, a user or other mechanical device may overcome a compressive force of the resilient member to move the valve stem 62 from the sealing configuration to the dispensing configuration. As the valve stem 62 moves from the sealing configuration to the dispensing configuration, the engagement member 68 compresses the resilient member 58. It is also to be appreciated that the resilient member 58 may be further compressed to move the valve stem 62 from a dispensing configuration to a filling configuration.

The valve stem 62 may include one or more orifices 108. The orifices 108 may be used for filling the container with product and/or propellant and dispensing product and/or propellant from the container. The one or more orifices 108 may be any shape or size so long as product and/or propellant may be at least one of filled and dispensed through such orifice. For example, the one or more orifices may be circular, oval, rectangular, square, or any other shape. The one or more orifices 108 may be tapered. For a valve stem 62 including two or more orifices, each of the orifices may be the same or different shapes and may be the same or different sizes. For example, when both a dispensing orifice and a filling orifice are included in the valve stem 62, the filling orifice may have a larger cross-sectional open area than the dispensing orifice. The orifice 108 may extend from the outer stem surface 92 to the inner stem surface 94. The orifice 108 may be in fluid communication with the channel 95 defined by the inner stem surface 94 such that product and/or propellent may flow through the orifice and into the channel 95. The product and/or propellant may flow from the container, through the orifice, and into the channel 95. The product and/or propellant may also flow through the channel, through the orifice, and into the container.

The one or more orifices 108 may be positioned about the valve stem 62 such that the release of product and/or propellant is controlled. The orifice 108 may be positioned between the first portion 86 of the valve stem 62 and at least a portion of the valve seal 82. Stated another way, the one or more orifices 108 may be positioned such that at least a portion of the valve seal 82 is located between the orifice and the third portion 90 of the valve stem 62 to prevent product and/or propellant from freely flowing from the container and through the orifice. The portion of the valve seal 82 positioned between the orifice and the third portion prevents product and/or propellant from flowing to the orifice prior to the valve stem being moved to a dispensing configuration. When the valve stem is in a sealing configuration, the valve seal 82 prevents product and/or propellant from accessing the orifice and contains the product and/or propellant within the container. A second portion of the valve seal 82 may be located between the orifice and the first portion 86 of the valve stem to prevent product and/or propellant from freely flowing through the inner passageway 74 and out the first passageway opening 76 as product and/or propellant flow through the orifice.

The valve stem 62 may include a third portion 90, opposite the first portion 86. The third portion 90 of the valve stem 62 may include a retaining member 110. The retaining member 110 may be joined to the third portion 90 of the valve stem 62 or the retaining member 110 may be formed with the remainder of the valve stem 62. The retaining member 110 may be formed from the same material as the other portions of the valve stem 62 or with a different material.

At least a portion of the retaining member 110 may extend outward, such as radially outward, beyond the outer stem surface 92 and may be configured to engage a portion of the valve body 54 and/or the valve seal 82. The retaining member may be axisymmetric or non-axisymmetric. The retaining member 110 may work in cooperation with the resilient member 58 to position the valve stem 62 in a sealed position. The retaining member 110 may be any shape such that a portion of the retaining member 110 may operatively engage at least one of a portion of the valve body 54 and the valve seal 82. The shape of the retaining member 110 may be such that the retaining member 110 maintains the position of the valve stem 62 during safe operating conditions and aids in safely moving the valve stem to vent the container during adverse operating conditions, such as relatively elevated temperatures and over pressurization of the aerosol dispenser.

As previously discussed, the valve stem 62 extends through the inner passageway 74 of the valve body 54. The valve stem 62 is positioned within the valve body 54 such that a portion of the valve stem 62 extends along the passageway surface 80 and through at least one of the first passageway opening 76 and the second passageway opening 78. The valve stem 62 includes an outer stem surface 92 and an inner stem surface 94. The inner stem surface 94 defines a channel 95 in fluid communication with a dispensing opening 116 through which product and/or propellant may be introduced into or dispensed from the container. The outer stem surface 92 may be configured to operatively engage at least one of the engagement member 68 and the resilient member 58 such that the resilient member 58 controls the movement of the valve stem 62. The engagement member 68 may include one or more protrusions to operatively engage a portion of the valve stem 62. The outer stem surface 92 may include one or more protrusions and/or notches to operatively engage the engagement member 68. The engagement member 68 may substantially surround the valve stem 62 and operatively engage the valve stem 62 such that moves with the valve stem 62.

The valve assembly 52 may include a valve seal 82, such as illustrated in FIGS. 8A-10B. The valve seal may be disposed on at least a portion of the passageway surface 80 and may extend about a portion of the passageway surface 80. The valve seal may be joined to the passageway surface 80 such that the valve seal remains in position as the valve stem 62 moves from the sealed configuration to a dispensing configuration or a filling configuration. The valve seal may extend from the passageway surface 80 toward the second passageway opening 78. The valve seal 82 may extend about the second passageway opening 78. The valve seal 82 may extend from the passageway surface 80 to the first passageway opening 76. The valve seal 82 may extend about the second passageway opening 78 without extending from the passageway surface 80. The valve seal 82 may be any shape such that a seal is formed with a portion of the valve stem 62 and product and/or propellant is contained within the container.

The valve seal 82 may include a first seal surface 102 and a second seal surface 104, which is opposite the first seal surface 102. The first seal surface 102 abuts at least one of a portion of the passageway surface 80 and the second passageway opening 78. The first seal surface 102 may be joined to at least one of a portion of the passageway surface 80 and the second passageway opening 78. At least a portion of the second seal surface may be in facing relationship with the valve stem 62 and a portion of the second seal surface 104 operatively engages a portion of the valve stem 62 to form a seal therewith. The valve stem 62 extends through the inner passageway 80 and includes an outer stem surface 92 and an inner stem surface 94. A portion of the second seal surface 104 operatively engages a portion of the outer stem surface 94. The valve stem 62 includes one or more orifices 108 that extend from the outer stem surface 94 to the inner stem surface 94 and are in fluid communication with the channel 95. The one or more orifices allow product and/or propellant to be dispensed from, or filled into, the container. These orifices 108 need to remain sealed when the valve stem 62 is in a sealed configuration. The valve seal 82 operatively engages the valve stem 62 to form a seal that prevents propellant and/or product from accessing the orifice when the valve stem 62 is in a sealed configuration. The valve seal 82 is configured to remain in a stationary position as the valve stem is moved from the sealed configuration to the dispensing configuration and from the dispensing configuration to a filling configuration. The movement of the valve stem with respect to the valve seal allows controlled dispensing and/or filling of product and/or propellant through the one or more orifices of the valve stem.

The valve seal may be made from a flexible material to aid in forming the seal. The valve seal may comprise a thermoplastic elastomer (TPE) or a rubber or any appropriate flexible material.

The valve assembly 52 may include a resilient member 58. The resilient member 58 may be disposed on a portion of the valve body 54. The resilient member 58 may be positioned adjacent to the first passageway opening 76 and substantially surround the longitudinal axis 70. The resilient member 58 may be any compliant member that provides resistance to a force providing movement of the valve stem 62 when the valve stem 62 is moved in a direction toward the container 32, such as to a dispensing configuration or a filling configuration, and returns the valve stem 62 to a sealing configuration, also referred to herein as a sealed configuration, when the force is removed or lessened. The resilient member 58 may be made from a polymer. The resilient member 58 may be any shape such that the resilient member 58 operatively engages the valve stem and controls the movement of the valve stem.

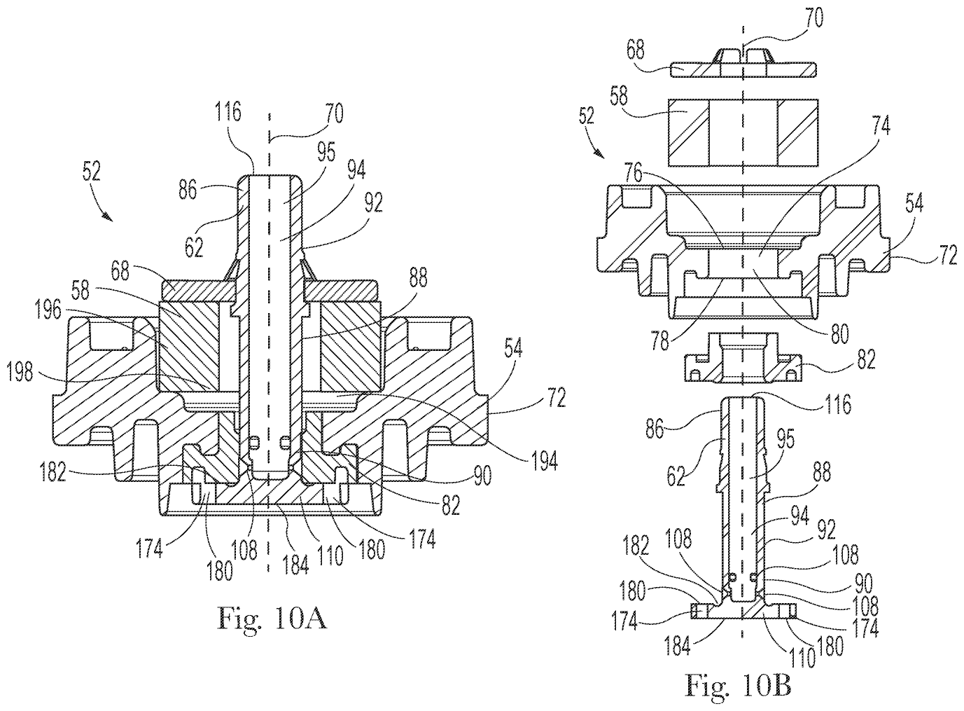

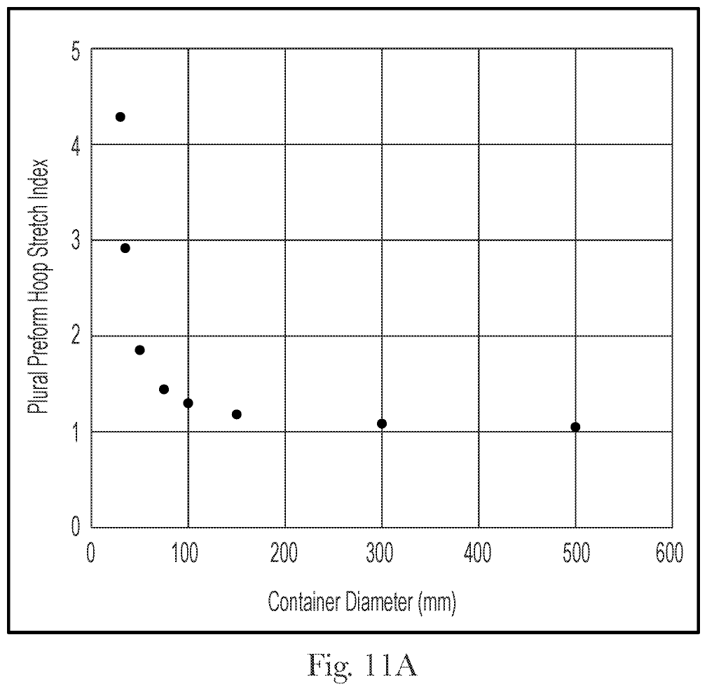

The resilient member 58 may be disposed on at least a portion of the first valve body surface 96, such as illustrated in FIGS. 9A and 10A. The resilient member 58 may include a first resilient member surface 190 and a second resilient member surface 192. The resilient member 58 may be positioned between the engagement member 68 and the first valve body surface 96. The second engagement member surface 188 may operatively engage at least a portion of the first resilient member surface 190 and the second resilient member surface 192 may be disposed on at least a portion of the first valve body surface 96. The second engagement member surface 188 may extend over the first resilient member surface 190 such that the engagement member 68 compresses the resilient member 58 as the valve stem 62 moves between the sealed, dispensing, and/or filling configuration.

The aforementioned components of the aerosol dispenser 30 may be polymeric. By polymeric it is meant that the component is formed of a material that includes polymers, and/or particularly polyolefins, polyesters, or nylons, EVOH, or mixtures thereof. Thus, the entire polymeric aerosol dispenser 30 or, specific components thereof, is free of metal. The container 32, and all other components, may comprise, consist essentially of, or consist of PET, PEF, PEN, Nylon, EVOH, PE, PP, TPE, or combinations thereof. All or substantially all of the components of the polymeric aerosol dispenser, excluding the propellant and product, may be configured to be accepted in a single recycling stream. All such materials, or a majority of the components of the aerosol dispenser 30 (excluding the propellant and product) may be comprised of a single class of resin according to ASTM D7611. Particularly, the majority of the aerosol dispenser 30 by weight may be PET. The majority of the valve assembly by weight may be PET. The majority of the product delivery device by weight may be PET.

In the aforementioned embodiments, the aerosol dispenser may include a base cup 48. A base cup 48 may be joined to a portion of the container 32.

### Example of Stretch Ratio Calculations

For the concurrently blown article 278 as illustrated in FIG. 4B, the plural preform assembly 220 as illustrated in FIG. 4A may have the following physical dimensions in millimeters:

| | | |
|---|---|---|
| Outer Container Inner Diameter (292) | DB | 59 |
| Outer Preform Inner Diameter (274) | DO | 11.5 |
| Inner Preform Inner Diameter (276) | DL | 7.0 |
| Inner Preform Wall Thickness (269) | TL | 1.6 |
| Gap Between Preforms (252) | G | 0.7 |

Using the calculations for hoop stretch defined above

| | | |
|---|---|---|
| Outer Preform Hoop Stretch Ratio | DB/DO | 5.1 |
| Inner Preform Hoop Stretch Ratio | DB/DL | 8.4 |
| Plural Preform Hoop Stretch Index | DO/DL | 1.6 |
| Inverse Plural Preform Hoop Stretch Index | DL/DO | 0.6 |

The outer preform 230 of the plural preform assembly 220 is made from a material including Polyethylene terephthalate (PET) copolymer Laser+® C (E60A) manufactured by DAK Americas LLC. This material is a copolymer PET resin used for two-stage ISBM processes in the manufacture of PET containers. The intrinsic viscosity of the E60A material is 0.81. ISBM containers produced with this material have a recommended hoop stretch ratio of approximately 5 to provide desired orientation without strain whitening. A plural preform assembly 220 having an outer preform made with the DAK E60A material may be concurrently blow molded in the ISBM process. The finished container has a relatively high degree of crystallinity and strength in the side walls with measured bottle/container burst strengths in excess of 2200 kPa. The article produced from the ISMB plural preform assembly includes a bag and container with similar strain hardening properties.

The inner preform 240 of the plural preform assembly 220, also referred to herein as a pair, is made from a material including of Polyethylene terephthalate (PET) copolymer PPK 60N manufactured by Plastipak Holdings, Inc. This material is a PET resin with a value of 0.6 for intrinsic viscosity. This lower value of intrinsic viscosity corresponds to a lower molecular weight material. Concurrently blow molded containers from a plural preform assembly 220 with the PPK 60N material included in the inner preform 240 do not have any indication of strain whitening due to overstretching in the ISBM process. For this example, the inner preform 240 has a hoop stretch ratio greater than 8.

By contrast, when this inner preform for the plural preform pair is comprised of the E60A PET, the inner preform becomes overstretched and shows strain whitening for samples that are successfully blow molded. The inner preform often tears and/or ruptures during the blowing process when the 0.81 intrinsic viscosity material is utilized.

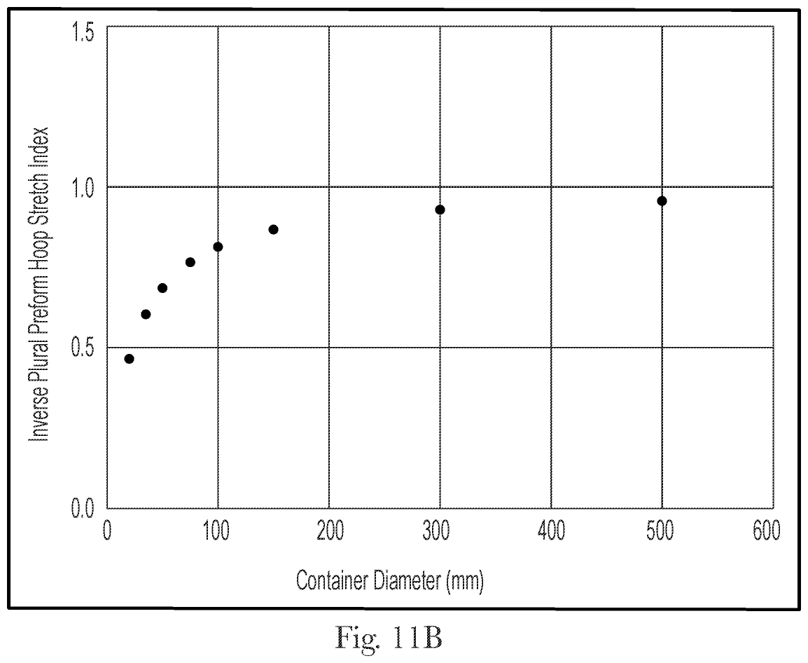

The hoop stretch for the inner and outer preforms for other sizes of containers may be calculated as in the example outlined above. Holding the outer preform hoop stretch ratio constant at a value of 5 and maintaining same preform thickness and preform gap, the inner preform stretch ratio rises precipitously for container diameters below approximately 100 mm. The plural preform hoop stretch index, which is the ratio of the inner preform hoop stretch ratio to outer preform hoop stretch ratio, is illustrated in FIG. 11A. An inner preform should be made from of a material that stretches to a relatively higher degree of orientation to avoid damage from overstretching.

By contrast, holding the inner preform hoop stretch ratio at a value of 5 and maintaining the same preform thickness and preform gap, the outer preform hoop stretch ratio drops precipitously for container diameters below approximately 100 mm. The inverse plural preform hoop stretch index, which is the ratio of the outer preform hoop stretch ratio to the inner preform hoop stretch ratio, is illustrated in FIG. 11B. The outer preform should be made from a material having a relatively higher intrinsic viscosity such that it will undergo sufficient strain hardening at lower stretch ratios as the container diameters are decreased. By contrast, if the outer preform is not made from a material having a higher intrinsic viscosity, processing difficulties and compromised physical properties due to a lack of orientation/crystallization in the container wall are relatively likely to occur.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A polymeric pressurized dispenser for dispensing a product, the aerosol dispenser comprising:
a container comprising a closed end bottom and a neck longitudinally opposed to the closed end bottom, wherein the neck defines an opening;
a valve assembly disposed in the neck of the container, wherein the valve assembly comprises:
a valve body joined to a portion of the container, wherein the valve body comprises an outer surface and an inner passageway extending about a longitudinal axis, wherein the inner passageway comprises a first passageway opening, a second passageway opening, and a passageway surface extending from the first passageway opening to the second passageway opening; and
a valve stem extending through the inner passageway of the valve body, wherein the valve stem is slidably engaged with a portion of the valve body;
a bag disposed within the container; and
a propellant disposed within the container, wherein the propellant is configured to pressurize the polymeric aerosol dispenser, and
wherein the container has a container intrinsic viscosity and the bag has a bag intrinsic viscosity, and wherein the bag intrinsic viscosity is less than the container intrinsic viscosity.

2. The polymeric aerosol dispenser of claim 1, comprising a valve seal joined to at least one of the valve body and the valve stem, wherein the valve seal is configured to operatively engage at least one of the valve body and the valve stem to form a seal therebetween.

3. The polymeric aerosol dispenser of claim 1, comprising a resilient member operatively engaged with the valve stem, wherein the resilient member is configured to control the movement of the valve stem.

4. The polymeric aerosol dispenser of claim 1, comprising a base cup joined to the bottom of the container.

5. The polymeric aerosol dispenser of claim 1, comprising an actuator joined to at least one of the container and the valve assembly.

6. The polymeric aerosol dispenser of claim 1, wherein the bag intrinsic viscosity is from about 0.5 to about 0.7.

7. The polymeric aerosol dispenser of claim 1, wherein the container intrinsic viscosity is from about 0.7 to about 0.9.

8. The polymeric aerosol dispenser of claim 1, wherein the container and the bag are formed by co-blowing a plural preform assembly, wherein the plural preform assembly comprises an outer preform and an inner preform.

9. A plural preform assembly for a container, the plural preform assembly having a longitudinal axis defining a longitudinal direction, the plural preform assembly comprising:
an outer preform having an outer preform open end and an outer preform closed end longitudinally opposed thereto, an outer preform sidewall joining the outer preform open end and the outer preform closed end, the outer preform having an outer preform inner surface and an outer preform outer surface; and
an inner preform disposed in the outer preform, the inner preform having an inner preform open end and an inner preform closed end longitudinally opposed thereto, an inner preform sidewall joining the inner preform open end and the inner preform closed end, the inner preform having an inner preform inner surface and an inner preform outer surface,
wherein the inner preform has an inner preform intrinsic viscosity and the outer preform has an outer preform intrinsic viscosity, and wherein the inner preform intrinsic viscosity and the outer preform intrinsic viscosity are different.

10. The plural preform assembly, wherein the inner preform and the outer preform comprise PET.

11. The plural preform assembly of claim 9, wherein the inner preform intrinsic viscosity is less than the outer preform intrinsic viscosity.

12. The plural preform assembly of claim 9, wherein the outer preform intrinsic viscosity is from about 0.7 to about 0.9 and the inner preform intrinsic viscosity is from about 0.5 to about 0.7.

13. The plural preform assembly of claim 9, wherein the difference between the inner preform intrinsic viscosity and the outer preform intrinsic viscosity is from about 0.1 to about 0.3.

14. The plural preform assembly of claim 9, wherein the difference between the inner preform intrinsic viscosity and the outer preform intrinsic viscosity is about 0.2.

15. The plural preform assembly of claim 9, wherein the inner preform intrinsic viscosity is from about 50% to about 80% of the outer preform intrinsic viscosity.

16. The plural preform assembly of claim 9, wherein the inner preform intrinsic viscosity is about 70% of the outer preform intrinsic viscosity.

17. The plural preform assembly of claim 9, wherein the inner preform has an inner diameter, and wherein the inner diameter of the inner preform is from about 5 mm to about 12 mm.

18. The plural preform assembly of claim 9, wherein the outer preform has an inner diameter, and wherein the inner diameter of the outer preform is from about 6 mm to about 15 mm.

19. The plural preform assembly of claim 9, wherein inner preform and the outer preform are joined at the respective open ends.

20. The plural preform assembly of claim 9, comprising a second inner preform disposed in the outer preform, wherein the second inner preform has a second preform intrinsic viscosity, and wherein the second preform intrinsic viscosity is less than the outer preform intrinsic viscosity.

21. A method of making a plural preform assembly for a bag in container assembly, the method comprising:
providing a plural preform assembly having a longitudinal axis extending in a longitudinal direction, the plural preform assembly comprising:
an outer preform having an outer preform open end and an outer preform closed end longitudinally opposed thereto, an outer preform sidewall joining the outer preform open end and the outer preform closed end, the outer preform having an outer preform inner surface and an outer preform outer surface; and
an inner preform at least partially disposed in the outer preform, the inner preform having an inner preform open end and an inner preform closed end longitudinally opposed thereto, an inner preform sidewall joining the inner preform open end and the inner preform closed end, the inner preform having an inner preform inner surface and an inner preform outer surface,
wherein the outer preform has an outer preform intrinsic viscosity and the inner preform has an inner preform intrinsic viscosity, and wherein the inner preform intrinsic viscosity is less than the outer preform intrinsic viscosity;
loading the plural preform assembly into a mold cavity; and
blow molding the plural preform assembly, wherein each of the inner preform and the outer preform are blown to substantially form to the mold cavity forming a bag in container assembly,
wherein the plural preform assembly has a plural preform hoop stretch index of greater than about 1.1.

22. The method of claim 21, wherein the plural preform hoop stretch index is about 1.6.

23. The method of claim 21, wherein the inner preform has an inner diameter of from about 5 mm to about 12 mm and the outer preform has an inner diameter of from about 6 mm to about 15 mm.

24. The method of claim 21, wherein the inner preform has an inner preform hoop stretch ratio of about 8.

25. The method of claim 21, wherein the outer preform has an outer preform hoop stretch ratio of about 5.
